(19) United States
(12) Patent Application Publication
(10) Pub. No.: US 2026/0288729 A1
(43) Pub. Date: Sep. 24, 2026

(54) METHODS AND DEVICES FOR DATA AGGREGATION AND RETRIEVAL

(71) Applicant: VeriFone, Inc., Wilmington, DE (US)

(72) Inventors: Darren Endo, Wilmington, DE (US); Jeremy Belostock, Wilmington, DE (US)

(73) Assignee: VeriFone, Inc., Wilmington, DE (US)

(21) Appl. No.: 19/480,181

(22) PCT Filed: May 1, 2023
(86) PCT No.: PCT/US2023/020584

§ 371 Date: Oct. 30, 2025

(51) Int. Cl. G06F 16/2455; G06F 21/60; H04L 67/025

(52) U.S. Cl. CPC G06F 16/24556; G06F 21/602; H04L 67/025

(57) ABSTRACT

Methods, devices, and non-transitory computer readable media for data aggregation and retrieval are provided herein. The methods, devices, and non-transitory computer readable media provide for generating a data pool and registering for a third-party application using a data pool.

### FIELD OF THE DISCLOSURE

The present disclosure is directed generally to methods, devices, and non-transitory computer readable media for data aggregation and retrieval.

### BACKGROUND

Joining into a new payment service or method most often requires an application process where specific inputs are required. For example, the consumer may be required to input personal identification data, as well as income data, to obtain approval for the new payment service. However, it may not be clear to the consumer what data will be required to apply for the payment service. This uncertainty yields low engagement and low to no meaningful conversion to the new payment service.

During an in-store purchase transaction, if the consumer discovers that a new payment service is available, but the consumer is not a member of such service, the consumer may be required to perform the steps of the application for the new payment service at the place and time of the transaction. If the user decides to apply for the new payment service, there is potential to create friction for the total consumer experience. For example, the consumer may not have direct access to all of the data required to complete the application process. Additionally, the time to complete the application may not meet the consumer's expectations. Further, the consumer may feel compelled to continue with the application beyond an unexpected, lengthy amount of time, which will detract from the consumer experience. Further, the application process may create frustration among other customers who must wait for the application process to be completed, as well as among the store operator/associate who must process the application.

### SUMMARY OF THE DISCLOSURE

The present disclosure is directed to methods, devices, and non-transitory computer readable media for data aggregation and retrieval. More specifically, the present disclosure is directed to methods, devices, and non-transitory computer readable media for generating a data pool and methods, devices, and non-transitory computer readable medium for registering for a third-party application using a data pool.

According to an example of the present disclosure, a method for generating a data pool is provided. The method includes: (i) providing, by a data aggregation and retrieval computing device, a web application to a user device, wherein the user device is registered to access the web application; (ii) receiving, by the data aggregation and retrieval computing device, a user identification of one or more applications associated with the user device, through the web application, from which the data aggregation and retrieval computing device can retrieve data; (iii) retrieving, by the data aggregation and retrieval computing device, data from the one or more applications received based on the user identification; and generating, by the data aggregation and retrieval computing device, the data pool by aggregating the data retrieved from the one or more applications.

In an aspect, the method further includes: (i) encrypting, by the data aggregation and retrieval computing device, the generated data pool; and (ii) storing, by the data aggregation and retrieval computing device, the data pool on a server for retrieval.

In an aspect, the method further includes: (i) receiving, by the data aggregation and retrieval computing device, a registration request for the user device; and generating, by the data aggregation and retrieval computing device, a user account associated with the user device in response to the received registration request.

In an aspect, the registration request comprises an authentication from a user associated with the user device.

In an aspect, the method further includes: (i) identifying, by the data aggregation and retrieval computing device, a list of applications associated with the user device; and (ii) providing, by the data aggregation and retrieval computing device, a first recommendation, to the user device, for one or more of the applications associated with the user device from the identified list for retrieving data prior to the user identification of the one or more applications from which the data aggregation and retrieval computing device can retrieve data.

In an aspect, the method further includes providing, by the data aggregation and retrieval computing device, a second recommendation, to the user device, for one or more applications not associated with the user device for retrieving data prior to the user identification of the one or more applications from which the data aggregation and retrieval computing device can retrieve data.

In an aspect, the data is retrieved from the one or more applications received based on the user identification periodically.

In an aspect, the method further includes: (i) receiving, by the data aggregation and retrieval computing device, a request from the user device to provide one or more registration data inputs for a third-party application; (ii) identifying, by the data aggregation and retrieval computing device, the one or more registration data inputs in the data pool; and providing, by the data aggregation and retrieval computing device, the identified one or more registration data inputs from the data pool to the third-party application.

In an aspect, the one or more registration data inputs are identified using a machine learning algorithm.

In an aspect, the method further includes: (i) retrieving, by the data aggregation and retrieval computing device, data from the third-party application; and storing, by the data aggregation and retrieval computing device, the data from the third-party application in the data pool.

In an aspect, the third-party application is an alternative payment method application.

According to another example of the present disclosure, a data aggregation and retrieval computing device is provided. The device comprises a memory comprising programmed instructions stored thereon, and one or more processors configured to be capable of executing the stored programmed instructions to: (i) provide a web application to a user device, wherein the user device is registered to access the web application; (ii) receive, a user identification of one or more applications associated with the user device, through the web application, from which the data aggregation and retrieval computing device can retrieve data; (iii) retrieve data from the one or more applications received based on the user identification; and (iv) generate the data pool by aggregating the data retrieved from the one or more applications.

According to a further example of the present disclosure, a non-transitory computer readable medium for generating a data pool is provided. The non-transitory computer readable medium has stored thereon instructions comprising executable code that, when executed by one or more processors, causes the processors to: (i) provide a web application to a user device, wherein the user device is registered to access the web application; (ii) receive, a user identification of one or more applications associated with the user device, through the web application, from which the data aggregation and retrieval computing device can retrieve data; (iii) retrieve data from the one or more applications received based on the user identification; and (iv) generate the data pool by aggregating the data retrieved from the one or more applications.

According to another example of the present disclosure, a method for registering for a third-party application is provided. The method includes: (i) providing, by a user computing device, a request to provide one or more registration data inputs for the third-party application through a web application; (ii) receiving, by the user computing device, the one or more registration data inputs from a data pool associated with the user computing device; and (iii) providing, by the user computing device, the one or more registration data inputs received from the data pool to a third-party service provider associated with the third-party application.

In an aspect, the third-party application an alternative payment method application.

In an aspect, the method further includes: (i) displaying, by user computing, a web application, wherein the user computing device is registered to access the web application; (ii) receiving, by the user computing device, a user identification of one or more applications associated with the user computing device, through the web application; and (iii) providing, by the user computing device, the user identification of the one or more applications to a data aggregation and retrieval computing device to form the data pool.

In an aspect, the method further includes providing, by user computing device, a registration request for the web application, wherein the registration request comprises an authentication from a user associated with the user computing device.

In an aspect, the registration request is initiated based on a QR code or a hyperlink.

According to another example of the present disclosure, a user computing device is provided. The user computing device includes a memory comprising programmed instructions stored thereon, and one or more processors configured to be capable of executing the stored programmed instructions to: (i) provide a request from to provide one or more registration data inputs for the third-party application through a web application; (ii) receive the one or more registration data inputs from a data pool associated with the user computing device; and (iii) provide the one or more registration data inputs received from the data pool to a third-party service provider associated with the third-party application.

According to yet another example of the present disclosure, a non-transitory computer readable medium for registering for a third-party application is provided. The non-transitory computer readable medium has stored thereon instructions comprising executable code that, when executed by one or more processors, causes the processors to: (i) provide a request from to provide one or more registration data inputs for the third-party application through a web application; (ii) receive the one or more registration data inputs from a data pool associated with the user computing device; and (iii) provide the one or more registration data inputs received from the data pool to a third-party service provider associated with the third-party application.

### BRIEF DESCRIPTION OF THE DRAWINGS

FIG. 1 is a diagram illustrating an environment including a data aggregation and retrieval computing device and a user computing device configured to perform the methods according to aspects of the present disclosure.

FIG. 2 is a block diagram of the data aggregation and retrieval computing device illustrated in FIG. 1 according to aspects of the present disclosure.

FIG. 3 is a block diagram of the user computing device illustrated in FIG. 1 according to aspects of the present disclosure.

FIGS. 4A and 4B are a flow diagram for generating a data pool according to aspects of the present disclosure.

FIG. 5 is a diagram illustrating the initial setup of a user account for generating a data pool according to aspects of the present disclosure.

FIG. 6 is a flow diagram for retrieval of data from a data pool according to aspects of the present disclosure.

FIG. 7 is a flow diagram for registering for a third-party application using a data pool according to aspects of the present disclosure.

### DETAILED DESCRIPTION

The present disclosure is directed to directed to methods, devices, and non-transitory computer readable media for data aggregation and retrieval. More specifically, the present disclosure is directed to methods, devices, and non-transitory computer readable media for generating a data pool and methods, devices, and non-transitory computer readable medium for registering for a third-party application using a data pool. According to examples of the present disclosure, a user can register with a third-party application in a streamlined manner. For example, the user can register for an alternative payment method at the point-of-sale without disrupting the flow of transactions. Further, the aggregated data can be used to identify user preferences, provide up-sale opportunities, and provide the user with enhanced payment options, for example.

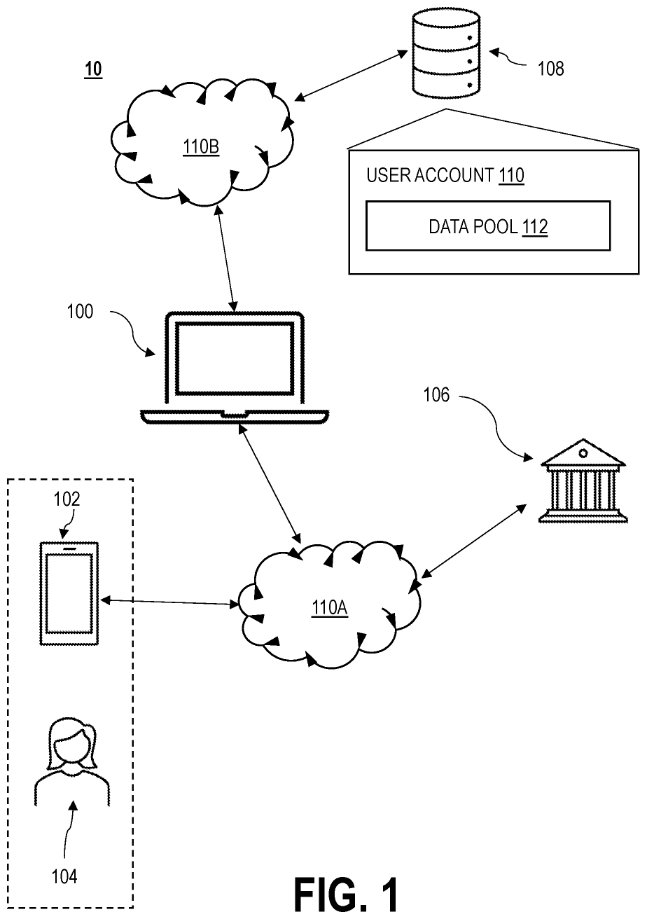

FIG. 1 illustrates an environment 10 including an exemplary data aggregation and retrieval payment authorization computing device 100 coupled to a user computing device 102 associated with a user 104, and a third-party financial application provider 106, by one or more communication network(s) 110A. The data aggregation and retrieval computing device 100 is further coupled to a database 112 by one or more communication network(s) 110B. Although the environment 10 is illustrated and described, the environment may include additional numbers and/or types of devices in other configurations. For example, although user computing device 102 and third-party financial application provider 106 are illustrated, it is to be understood that the environment 10 may include any number of user computing devices and third-party financial application providers (or other types of application providers) coupled to data aggregation and retrieval computing device 102 to provide for generation of a data pool and retrieval of data therefrom for registering for a third-party application in accordance with the methods disclosed herein. The technology of the present disclosure advantageously allows for streamlined registration, for example, for alternative payment methods. The technology will encourage users to engage with alternative payment methods and provide enhanced payment flexibility.

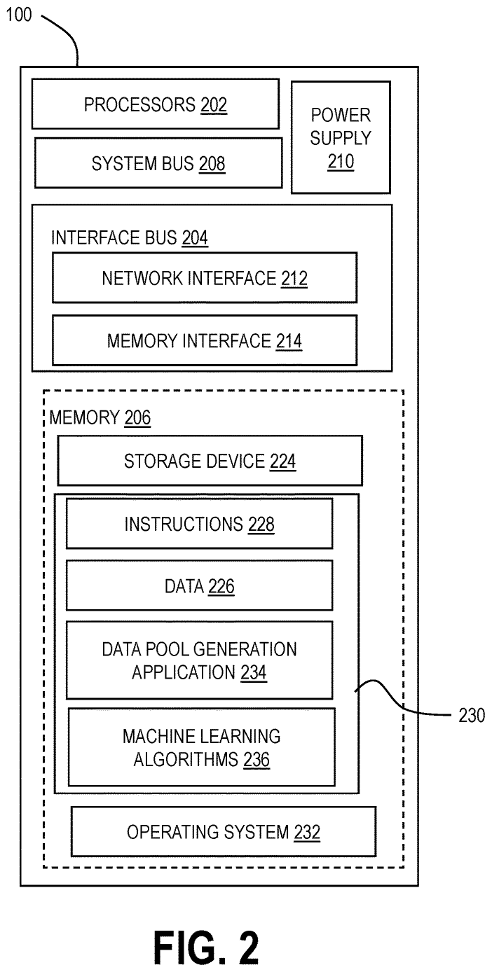

Data aggregation and retrieval computing device 100 is configured to provide for generating a data pool that can be utilized, for example, for retrieval of data during registration for a third-party application, such as an alternative payment method, according to aspects of the present disclosure. With reference to FIG. 2, a block diagram of the data aggregation and retrieval computing device 100 is illustrated according to aspects of the present disclosure. In the example of FIG. 2, the data aggregation and retrieval computing device 100 can include one or more processors 202, an interface bus 204, and machine-readable memory 206, all of which may be interconnected and/or communicate through a system bus 208 containing conductive circuit pathways through which instructions (e.g., machine-readable signals) may travel to effectuate communication, tasks, storage, and the like. The data aggregation and retrieval computing device 100 may be connected to a power source 210, which can include an internal power supply and/or an external power supply.

The one or more processors 202 may include a high-speed data processor adequate to execute the program components described herein and/or various specialized processing units as may be known in the art. In some examples, the one or more processors 202 may be a single processor, multiple processors, or multiple processor cores on a single die.

In some examples, the interface bus 204 may include a network interface 212 configured to connect and communicate with one or more connected electronic devices, including user computing device 102, third-party financial application provider 106, and/or database 108, for example, through the one or more communications network(s) 110A and/or 110B, as shown in FIG. 1, and/or a memory interface 214 configured to accept, communicate, and/or connect to a number of machine-readable memory devices (e.g., memory 206).

The memory 206 can be variously embodied in one or more forms of machine-accessible and machine-readable memory. In some examples, the memory 206 includes a storage device 224 that comprises one or more types of memory. For example, the storage device 224 can include, but is not limited to, a non-transitory storage medium, a magnetic disk storage, an optical disk storage, an array of storage devices, a solid-state memory device, and the like, including combinations thereof.

Generally, the memory 206 is configured to store data/information 226 and instructions 228 that, when executed by the one or more processors 202, causes the data aggregation and retrieval computing device 100 to perform one or more tasks. In particular examples, the memory 206 includes a controller package 230 that comprises a collection of program components, database components, and/or data configured to, when executed by the one or more processors 202, cause the data aggregation and retrieval computing device 100 to perform one or more of the steps of the methods described herein for generating a data pool. According to the present disclosure, the controller package 230 may include, but is not limited to, instructions 228 having one or more software packages configured to perform one or more of the steps of the methods disclosed herein. These software packages may be incorporated into, loaded from, loaded onto, or otherwise operatively available to and from the data aggregation and retrieval computing device 100.

In particular examples, the memory 206 may include a data pool generation application 234 that comprises a collection of program components, database components, and/or data. The data pool generation application 234 may be a progressive web application (PWA) that may be rendered on a display screen of the user computing device 102 to receive one or more inputs according to aspects of the present disclosure. According to the present disclosure, the data pool generation application 234 may include, but is not limited to, instructions 228 that control/operate the display screen of the user computing device 102 to receive inputs for data pool generation, including an identification from user 104 of applications associated with the user computing device 102 from which the data aggregation and retrieval computing device 100 can extract and aggregate data to form the data pool 112 for user 104. The data pool generation application 234 may also be utilized to provide other information to the data aggregation and retrieval computing device 100, such as a request to register for a third-party application for which data can be retrieved from the data pool 112 according to aspects of the present disclosure. In particular examples, the memory 206 may also include machine learning algorithms 236 that may be used to analyze the data stored in the data pool 112. Any machine learning algorithms 236 known in the art may be employed.

In embodiments, the data aggregation and retrieval computing device 100 includes at least an operating system component 232, which may be stored in the memory 206. The operating system component 232 may be an executable program facilitating the operation of the controller package 230. Typically, the operating system component 232 can facilitate access of the network interface 212 and memory interface 214, and can communicate with other components of the data aggregation and retrieval computing device 100.

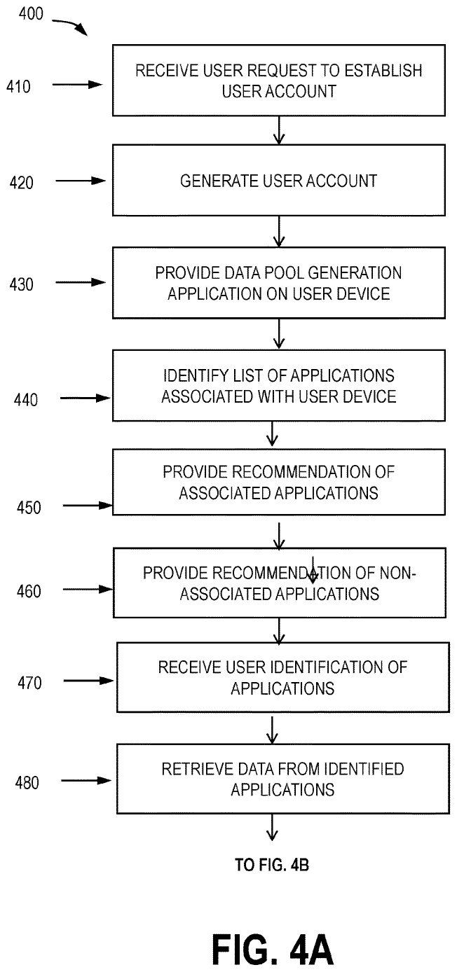

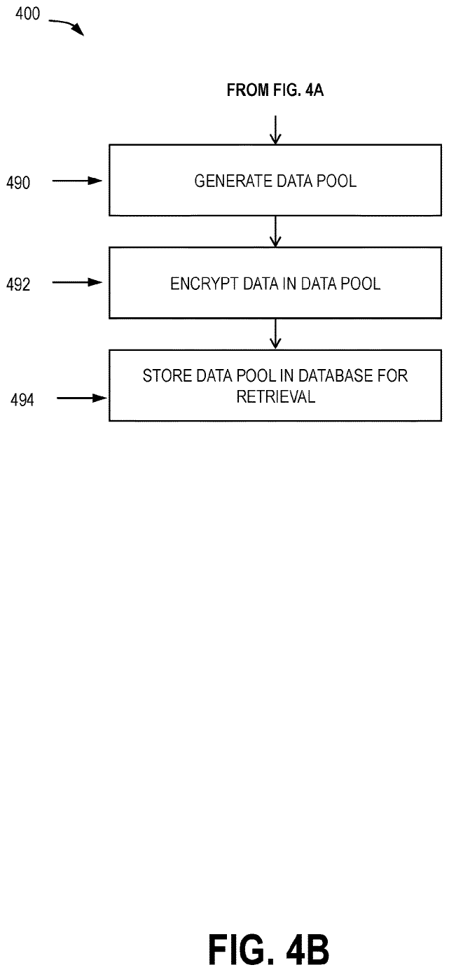

Referring again to FIG. 1, the data aggregation and retrieval computing device 100 is communicatively coupled to database 108 through the one or more communication network(s) 110B. The database 108 can be used, in some examples, to store information related to the methods performed by the data aggregation and retrieval computing device 100 according to aspects of the present disclosure. In this example, the database 108 includes user account 110 for the user 104 who has registered to utilize data pool 112 through the data aggregation and retrieval computing device 100 for the aggregation, retrieval, abstraction, and calculation, as described in further detail below, for example, in FIGS. 4, 6, and 7. Although user account 110 for the user 104 is illustrated and described, it is to be understood that the database 108 can include any number of user accounts for any number of users to utilize the methods for generating a data pool and retrieving information therefrom, for example, for registering for a third-party application through third-party financial application provider 106, by way of example only, according to aspects of the present disclosure.

In this example, the user account 110 is associated with the user 104 and includes stored account data related to the user gather during the initial set-up and registration process, as described below, as well as the data pool 112 for user, generated according to the method described below with respect to FIG. 4. In one example, the data pool 112 can include various types of information retrieved from applications associated with the user computing device 102. By way of example, the data pool 112 could include financial information gathered from applications associated with the user computing device 102 that could be used to register for an alternative payment method. Such information may include, but is not limited to, address or other contact information, financial information such as income or credit data, etc. Although certain types of information are described, it is to be understood that the data pool 112 can retrieve and aggregate any forms of data associated with applications stored on the user computing device 102 in accordance with user permissions as described below. Thus, the information that can be aggregated by the data aggregation and retrieval computing device 100 is not intended to be limited by the disclosures herein.

Referring again to FIG. 1, data aggregation and retrieval computing device 100 is communicatively coupled to the user computing device 102 through the one or more communication network(s) 110A to transmit and/or receive communications in accordance with aspects of the present disclosure.

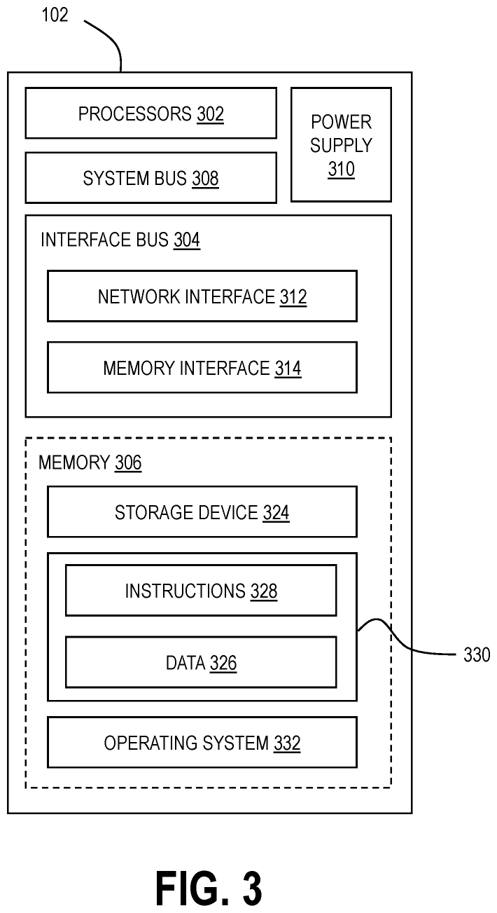

FIG. 3 illustrates one example of the user computing device 102. In this example, user computing device 102 is a mobile device, although other computing devices may be operated as the user computing device 102 according to aspects of the present disclosure. In the example of FIG. 3, the user computing device 102 includes one or more processors 302, an interface bus 304, and a memory 306, all of which may be interconnected and/or communicate through a system bus 308 containing conductive circuit pathways through which instructions (e.g., machine-readable signals) may travel to effectuate communication, tasks, storage, and the like. The user computing device 102 may be connected to a power source 310, which can include an internal power supply and/or an external power supply.

The one or more processors 302 may include a high-speed data processor adequate to execute the program components described herein and/or various specialized processing units as may be known in the art. In some examples, the one or more processors 302 may be a single processor, multiple processors, or multiple processor cores on a single die. In particular examples, the one or more processors 302 are configured to render and interact with the data pool generation application 234 stored on the data aggregation and retrieval computing device 100 according to aspects of the present disclosure.

In some examples, the interface bus 304 may include a network interface 312 configured to connect the user computing device 102 to a communications network, such as the one or more communication network(s) 110A shown in FIG. 1, and/or a memory interface 316 configured to accept, communicate, and/or otherwise connect the user computing device 102 to a number of machine-readable memory devices (e.g., memory 306). In some examples, the user computing device 102 may transmit and/or receive information via the communication network(s) 110A to and/or from the data aggregation and retrieval computing device 100, for example.

The memory 306 can be variously embodied in one or more forms of machine-accessible and machine-readable memory. In some examples, the memory 306 may include a storage device 318 that comprises one or more types of memory. For example, the storage device 318 can include, but is not limited to, a non-transitory storage medium, a magnetic disk storage, an optical disk storage, an array of storage devices, a solid-state memory device, and the like, including combinations thereof.

Generally, the memory 306 is configured to store data/information 326 and/or instructions 328 that, when executed by the one or more processors 302, causes the user computing device 102 to perform one or more tasks. In particular examples, the memory 206 includes a controller package 230 that comprises a collection of program components, database components, and/or data configured to, when executed by the one or more processors 202, cause the data aggregation and retrieval computing device 100 to perform one or more of the steps of the methods described herein for generating a data pool. According to the present disclosure, the controller package 230 may include, but is not limited to, instructions 228 having one or more software packages configured to perform one or more of the steps of the methods disclosed herein. These software packages may be incorporated into, loaded from, loaded onto, or otherwise operatively available to and from the user computing device 102.

As shown in the example of FIG. 3, the user computing device 102 may further include an operating system component 332, which may be stored in the memory 306. The operating system component 332 may be an executable program facilitating the operation of the user computing device 102, including but not limited to, operation of the remote payment authorization application 334. Typically, the operating system component 332 can facilitate access of the interface bus 304 and can communicate with other components of user computing device 102 (e.g., user input device, display screen, etc.).

Referring again to FIG. 1, the data aggregation and retrieval computing device 100 is communicatively coupled to the third-party financial application provider 106 by the one or more communication network(s) 110A. In this example, the third-party financial application provider 106 is associated with an entity that provides for alternative payment methods, such as card wallets, carrier billing, e-wallets, mobile wallets, pass-through wallets, pre-paid vouchers, virtual cards, buy now-pay later services, etc. As described in the examples below, the third-party financial application provider 106 can receive input information from the data aggregation and retrieval computing device 100 retrieved from the data pool 112 to provide an automated registration request seeking authorization to utilize the services of the third-party financial application provider 106 through the one or more communication network(s) 110B.

Communication network(s) 110A and 110B can include a direct interconnection (i.e., wired), the Internet, a local area network (LAN), a metropolitan area network (MAN), a wide area network (WAN), a wired or Ethernet connection, a wireless connection, and similar types of communications networks, including combinations thereof, and may utilize a variety of information transfer protocols and/or security features (e.g., encryption, etc.). Although the communication networks 110A and 110B are illustrated for communications between specific devices, it is to be understood that other communication configurations could be employed.

Turning now to FIGS. 4A and 4B, a flow diagram for a method 400 for generating a data pool utilizing the data aggregation and retrieval computing device 100 will not be described with reference to FIGS. 1-5.

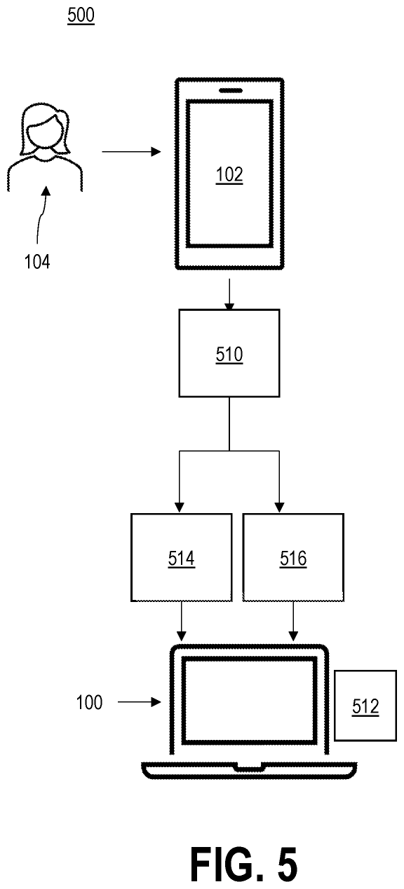

In step 410, the data aggregation and retrieval computing device 100 receives a request from the user computing device 100 to establish the user account 110 for forming the data pool 112. FIG. 5 illustrates an example of the registration and initialization process 500 for the user 104 to establish the user account 110. In some examples, the user 104 may scan a QR code or enter a link on the user computing device 102 to access an application instance 510 of the web-based data pool generation application 234 on the user computing device 510.

Within the application instance 510 of the data pool generation application 234, the user 104 can register with a web-based service 512 associated with the data aggregation and retrieval computing device 100. That is, a registration request 514 may be sent via the application instance 510 executed on the user computing device 102 of the user 104.

In some examples, the user 104 provides user information with the registration request 514, including but not limited to, the user's 104 name, contact information, biographical information, and/or authorized devices. Other information may include a username, account identification, and/or credentials used to access the user account 110 after registration. In further examples, the user 104 also provides an authentication factor 516 for associating the user 104 with the user account 110 after registration. In one example, the authentication factor 516 is a bio-authentication factor, such as for example a facial scan or a fingerprint that can be entered through the user computing device 102 to associate the user 104 with the user account 110 after registration. In particular examples, the user computing device 102 includes a user input device, which the user 104 may use to input the user information. For instance, the user input device may include, but is not limited to, a touch-enabled display screen, a keyboard, and the like.

Referring again to FIGS. 4A and 4B, in step 420 the data aggregation and retrieval computing device 100 generates the user account 110 for user 104 that allows the user 104 to access the web-based data pool generation application 234 on the user computing device. The user account 110 allows the user 104 to access the web-based data pool generation application 234 using the authentication factor 516, such as a bio-authentication factor provided during the registration process described with respect to FIG. 4. The user account 110 allows the user 104 to access and communicate with the web-based data pool generation application 234, for example, using encrypted communications. In some examples, the user 104 may be required to provide the authentication factor 516 for each use of the data pool generation application 234.

In step 430, the data aggregation and retrieval computing device 100 provides the web-based data pool generation application 234 for rendering on the display interface of the user computing device 102. The user 104 can select applications associated with the user computing device 102 to define the data pool 112, which includes data pulled from the selected applications. The user 104 can select any applications associated with the user computing device 102 to allow data extraction from those applications for the data pool 112. The applications can include banking applications, social media applications, shopping applications, etc. Although sample applications are listed, the types of applications from which data can be extracted for the data pool 112 are not intended to be limited by the disclosure herein.

In one example, the data pool generation application 234 can provide a list of applications associated with the user computing device 102 from which the user 104 can multi-select a number of applications. Alternatively, the data pool generation application 234 can provide an array of application icons for the applications associated with the user computing device 102, such that the user 104 can drag and drop the icons for the selected applications into a repository to define the data pool 112.

In accordance with some examples, the data aggregation and retrieval computing device 100, through the data pool generation application 234, encourages the user 104 to add a number of applications to provide a robustness to the data pool 112. In optional step 440, the data aggregation and retrieval computing device 100 identifies a list of applications associated with the user computing device 102. The data aggregation and retrieval computing device then, in step 450, analyzes the list of applications identified and provides a recommendation to the user computing device 102 for one or more of the applications from the identified list that are optimal for retrieving data for the data pool 112. For example, the data aggregation and retrieval computing device 100 may identify certain applications from which relevant data is likely to be extracted. Thus, the selection of applications by the user 104 can be guided by the data aggregation and retrieval computing device 100.

In another example, in optional step 460, the data aggregation and retrieval computing device 100 provides a recommendation, to the user computing device 102, for one or more applications not associated with the user computing device 102. That is, the data aggregation and retrieval computing device 100 identifies applications that the user 104 is not currently utilizing that may be helpful in generating the data pool 112. Thus, the user 104 can opt to download and utilize the applications recommended in optional step 460 to enhance the robustness of the data pool 112.

Next, in step 470, the data aggregation and retrieval computing device 100 receives a user identification or selection of applications associated with the user computing device 102 from which to extract data as discussed in step 430. Then, in step 480 the data aggregation and retrieval computing device 100 retrieves data from the applications selected in step 470 through user authorizations for the applications to communicate and exchange data. In some examples, the data aggregation and retrieval computing device 100 can retrieve data from the identified applications periodically to ensure that the data stored in the data pool 112 is up to date.

In step 490, the data aggregation and retrieval computing device 100 aggregates the data retrieved in step 480 to generate the data pool 112. The data pool 112 provides a set of aggregated data that can be used, for example, to register for a third-party application, such as an alternative payment application, as described in the methods discussed below. In step 492, the data aggregation and retrieval computing device 100 encrypts the data in the generated data pool 112 using known encryption techniques and in step 494 stores the data pool 112, for example, in the database 108 in association with the user account 110 for retrieval in accordance with the methods described herein.

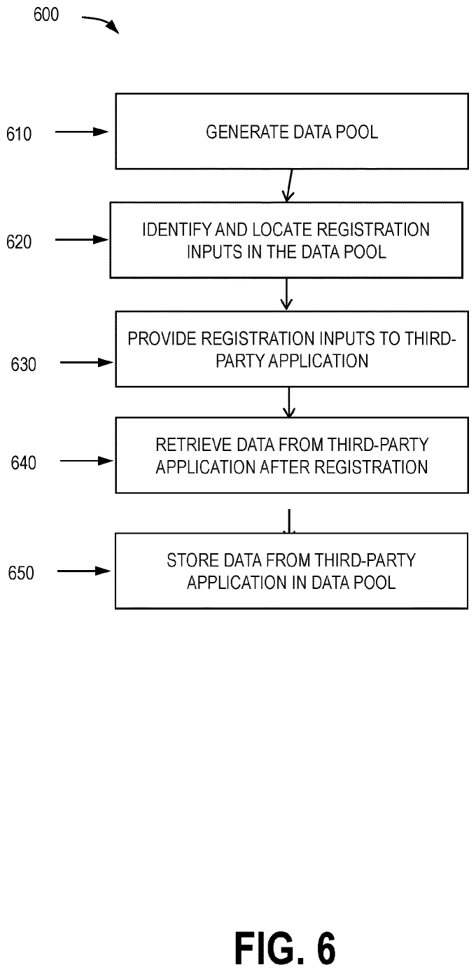

Turning now to FIG. 6, a flow diagram for a method 600 for generating a data pool utilizing the data aggregation and retrieval computing device 100 will not be described with reference to FIGS. 1-6.

In step 610, the data aggregation and retrieval computing device 100 receives a request from the user computing device 100 to provide one or more registration data inputs for a third-party application. For example, the user 104 may be seeking to register with an alternative payment method provided by third-party financial application provider 106 during a transaction. Although registration for an alternative payment method is described, it is to be understood that the method disclosed could be used to retrieve data related to any registration process and is not limited by the disclosure herein. The user 104 may as part of the registration process log into the data pool generation application 234 using the authentication factor 516. The request can then be provided through the data pool generation application 234, by way of example.

In step 620, the data aggregation and retrieval computing device 100 identifies one or more registration data inputs required for registration with the third-party application and locates the required information in the data pool 112. By way of example, the data aggregation and retrieval computing device 100 may apply known machine learning techniques to identify and locate the required information. In this manner, the user 104 avoids having to manually input the required information and streamlines the approval process.

In step 630, the data aggregation and retrieval computing device 100 provides the identified registration data inputs from the data pool 112 to the third-party application to complete the registration process. The methods disclosed herein advantageously streamline the onboarding process and remove impediments to utilizing alternative payment methods, for example. By way of example, the third-party financial application provider 106 can then render a decision on whether to accept the registration request provided by the user 104. In some examples, if the registration request is denied, the data aggregation and retrieval computing device 100 may provide recommendations regarding alternative payment methods. The data aggregation and retrieval computing device 100 can also provide additional information to the user based on the transaction. For example, the data aggregation and retrieval computing device 100 can analyze the data in the data pool 112 to provide additional purchase suggestions based on identified user preferences. The data aggregation and retrieval computing device 100 can provide recommendations, for example, based on historic user activity identified from the data pool 112.

Optionally, the third-party application can also be added to the applications from which data is extracted to form the data pool. In step 640, the data aggregation and retrieval computing device 100 retrieves data from the third-party application. In step 650, the data from the third-party application is stored in the data pool 112 to enhance the robustness and functionality of the data pool 112.

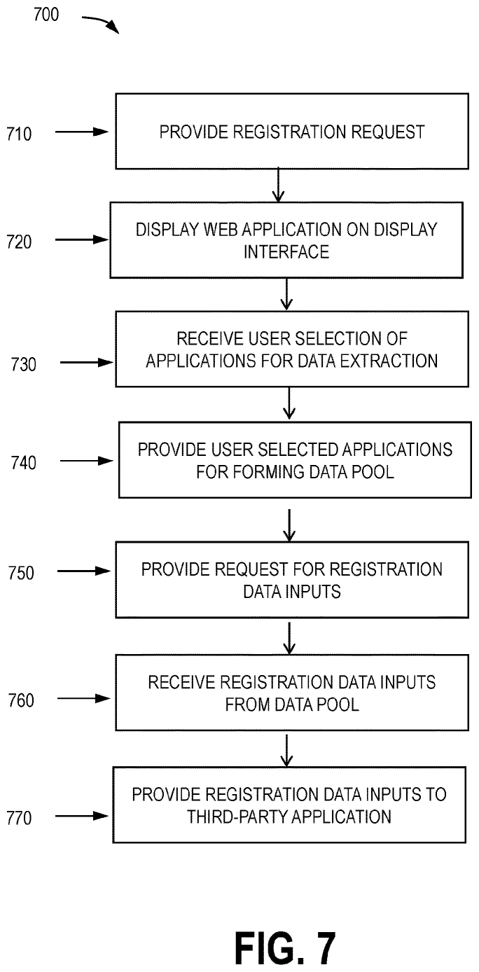

Turning now to FIG. 7, a method 700 for registering for a third-party application using a data pool according to aspects of the present disclosure is illustrated. In some example, the method disclosed herein can be utilized by the user 104, for example, at a point-of-sale location to register for a third-party application, such as an alternative payment method. Although an example is described, the registration method disclosed herein utilizing the data pool could be used in other contexts for other purposes.

In step 710, the user computing device 102 provides a registration request for a third-party application, such as alternative payment application operated, for example, by the third-party financial application provider 106. In some examples, the registration request is initiated based on a QR code or a hyperlink entered into an input interface of the user computing device 102. The registration request may also include an authentication factor, such as a bio-authentication factor (e.g., facial scan or fingerprint) from the user 104 associated with the user computing device 102.

In this example, the user computing device 102 is registered to access a web application, such as the web-based data pool generation application 234 described above. The user computing device 102 can provide inputs, through the data pool generation application 234 to assist in forming a data pool, such as data pool 112. In step 720, the user computing device 102 displays the web application, such as data pool generation application 234 on a display interface of the user computing device 102. In step 730, the user computing device 102 receives a user identification of one or more applications associated with the user computing device 102, through the web application as described above with respect to step 430 of FIG. 4A above. The applications can be selected using an input interface, such as a display screen, a keyboard, or a mouse, by way of example. In step 740, the user computing device 102 provides the user identification of the one or more applications to the data aggregation and retrieval computing device 100, for example, to form the data pool 112 in accordance with the methods disclosed herein.

In step 750, the user computing device 102 provides a request to provide one or more registration data inputs for the third-party application through a web application, such as the web-based data pool generation application 234, which the user 104 is registered with in accordance with the methods described above. In step 760, the user computing device 102 receives the registration data inputs from a data pool, such as the data pool 112, described above, associated with the user computing device 102. Next, in step 770, the user computing device 102 provides the one or more registration data inputs received from the data pool 112 to a third-party service provider, such as the third-party financial application provider 106, associated with the third-party application. The third-party can then in some examples render a decision on whether to register the user 104 for the provided service. Receiving the registration data inputs from the data pool 112 streamlines the registration process.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A method for generating a data pool, the method comprising:
providing, by a data aggregation and retrieval computing device, a web application to a user device, wherein the user device is registered to access the web application;
receiving, by the data aggregation and retrieval computing device, a user identification of one or more applications associated with the user device, through the web application, from which the data aggregation and retrieval computing device can retrieve data;
retrieving, by the data aggregation and retrieval computing device, data from the one or more applications received based on the user identification; and
generating, by the data aggregation and retrieval computing device, the data pool by aggregating the data retrieved from the one or more applications.

2. The method of claim 1 further comprising:
encrypting, by the data aggregation and retrieval computing device, the generated data pool; and
storing, by the data aggregation and retrieval computing device, the data pool on a server for retrieval.

3. The method of claim 1 further comprising:
receiving, by the data aggregation and retrieval computing device, a registration request for the user device; and
generating, by the data aggregation and retrieval computing device, a user account associated with the user device in response to the received registration request.

4. The method of claim 3, wherein the registration request comprises an authentication from a user associated with the user device.

5. The method of claim 1 further comprising:
identifying, by the data aggregation and retrieval computing device, a list of applications associated with the user device; and
providing, by the data aggregation and retrieval computing device, a first recommendation, to the user device, for one or more of the applications associated with the user device from the identified list for retrieving data prior to the user identification of the one or more applications from which the data aggregation and retrieval computing device can retrieve data.

6. The method of claim 5 further comprising:
providing, by the data aggregation and retrieval computing device, a second recommendation, to the user device, for one or more applications not associated with the user device for retrieving data prior to the user identification of the one or more applications from which the data aggregation and retrieval computing device can retrieve data.

7. The method of claim 1, wherein the data is retrieved from the one or more applications received based on the user identification periodically.

8. The method of claim 1 further comprising:
receiving, by the data aggregation and retrieval computing device, a request from the user device to provide one or more registration data inputs for a third-party application;
identifying, by the data aggregation and retrieval computing device, the one or more registration data inputs in the data pool; and
providing, by the data aggregation and retrieval computing device, the identified one or more registration data inputs from the data pool to the third-party application.

9. The method of claim 8, wherein the one or more registration data inputs are identified using a machine learning algorithm.

10. The method of claim 8, further comprising:
retrieving, by the data aggregation and retrieval computing device, data from the third-party application; and
storing, by the data aggregation and retrieval computing device, the data from the third-party application in the data pool.

11. The method of claim 8, wherein the third-party application is an alternative payment method application.

12. A data aggregation and retrieval computing device comprising a memory comprising programmed instructions stored thereon, and one or more processors configured to be capable of executing the stored programmed instructions to:
provide a web application to a user device, wherein the user device is registered to access the web application;
receive, a user identification of one or more applications associated with the user device, through the web application, from which the data aggregation and retrieval computing device can retrieve data;
retrieve data from the one or more applications received based on the user identification; and
generate the data pool by aggregating the data retrieved from the one or more applications.

13. A non-transitory computer readable medium for generating a data pool having stored thereon instructions comprising executable code that, when executed by one or more processors, causes the processors to:
provide a web application to a user device, wherein the user device is registered to access the web application;
receive, a user identification of one or more applications associated with the user device, through the web application, from which the data aggregation and retrieval computing device can retrieve data;
retrieve data from the one or more applications received based on the user identification; and
generate the data pool by aggregating the data retrieved from the one or more applications.

14. A method for registering for a third-party application, the method comprising:
providing, by a user computing device, a request to provide one or more registration data inputs for the third-party application through a web application;
receiving, by the user computing device, the one or more registration data inputs from a data pool associated with the user computing device; and
providing, by the user computing device, the one or more registration data inputs received from the data pool to a third-party service provider associated with the third-party application.

15. The method of claim 14, wherein the third-party application an alternative payment method application.

16. The method of claim 14 further comprising:
displaying, by user computing, a web application, wherein the user computing device is registered to access the web application;
receiving, by the user computing device, a user identification of one or more applications associated with the user computing device, through the web application; and
providing, by the user computing device, the user identification of the one or more applications to a data aggregation and retrieval computing device to form the data pool.

17. The method of claim 16 further comprising:
providing, by user computing device, a registration request for the web application, wherein the registration request comprises an authentication from a user associated with the user computing device.

18. The method of claim 17, wherein the registration request is initiated based on a QR code or a hyperlink.

19. A user computing device comprising a memory comprising programmed instructions stored thereon, and one or more processors configured to be capable of executing the stored programmed instructions to:
provide a request from to provide one or more registration data inputs for the third-party application through a web application;
receive the one or more registration data inputs from a data pool associated with the user computing device; and
provide the one or more registration data inputs received from the data pool to a third-party service provider associated with the third-party application.

20. A non-transitory computer readable medium for registering for a third-party application having stored thereon instructions comprising executable code that, when executed by one or more processors, causes the processors to:
provide a request from to provide one or more registration data inputs for the third-party application through a web application;
receive the one or more registration data inputs from a data pool associated with the user computing device; and
provide the one or more registration data inputs received from the data pool to a third-party service provider associated with the third-party application.
